(19) United States
(12) Patent Application Publication
(10) Pub. No.: US 2018/0003153 A1
(43) Pub. Date: Jan. 4, 2018

(54) CALIBRATING A WIND VANE OF A WIND TURBINE

(71) Applicant: KK WIND SOLUTIONS A/S, Ikast (DK)

(72) Inventor: Chris Damgaard, Herning (DK)

(21) Appl. No.: 15/543,606

(22) PCT Filed: Jan. 28, 2016
(86) PCT No.: PCT/DK2016/050025

§ 371 Date: Jul. 14, 2017

(30) Foreign Application Priority Data
Jan. 28, 2015 (DK) PA 2015 00045

(51) Int. Cl. F03D 7/02; F03D 7/04

(52) U.S. Cl. CPC F03D 7/0204; F03D 7/042; F05B 2270/335; F05B 2270/321; F05B 2270/20; F05B 2270/802; F05B 2270/329

(57) ABSTRACT

A method of determining an offset angle to the wind direction measured from a wind vane of a wind turbine includes the steps of: defining a plurality of power bins representing an interval of power which can be produced by the wind turbine, calculating an efficiency of the wind turbine for a plurality of time slots, determining a power output of the wind turbine for the plurality of time slots, comparing the efficiency of the wind turbine in two different time slots, and updating a value of the one of the power bins representing the interval of power determined for one of the compared time slots. The value of the power bin is updated with the result of the highest efficiency or a value derived from the highest efficiency multiplied with a constant.

### FIELD OF THE INVENTION

The invention relates to a method for determining a calibration offset angle for a plurality of different power intervals and using this calibration offset angle to optimise yaw control of a wind turbine.

### BACKGROUND OF THE INVENTION

Modern wind turbines are often of a size of 3MW or more and therefore it is easy to measure even minor optimizations of control of such large wind turbines in power production especially when production is measured over a period of several years.

Especially for a wind turbine which is not in front or behind of another wind turbine in a wind park, one way of optimizing the control is by making sure that the rotor plane (which is defined by the plan in which the blades rotates) is as close to perpendicular to the wind direction as possible. This type of wind turbine control is referred to as yaw control i.e. aligning the wind turbine (more specific the main shaft) with the wind direction.

The prior art includes several documents describing different ways of aligning the wind turbine with the wind direction of which U.S. Pat. No. 8,476,780 and U.S. Pat. No. 7,952,215 is two examples.

U.S. Pat. No. 8,476,780 describes to estimate the actual direction of the wind in advance of producing power. Two main embodiments are described the first making use of a quadratic approximated curve derived from an approximate expression and the second making use of an approximated curve made using a gradient method (see column 6 line 66 to Column 7 line 4). In both embodiments the result is an estimate of the actual wind direction by approximating the average generator output power with respect to a wind direction offset value which has been assumed to a quadratic curve at the time when the approximated average generator output power is the maximum in the quadratic curve (see claims 1 and 2).

U.S. Pat. No. 7,952,215 describes to sequentially accumulate data sets of generated output power during operation of the wind turbine, estimated wind speed and wind direction deviation which is defined as the difference between a measured wind direction and the orientation of the nacelle. These data sets are analysed and a distribution curve corresponding to the wind direction deviation of the generated output power at each incoming wind speed is determined. Then the wind direction deviation corresponding to the peak of the distribution curve is set as a correction value of an anemoscope and is stored for each incoming wind speed. In this way the wind direction measured at the anemoscope is corrected with the correction value of the anemoscope for each incoming wind speed and power production control is carried out using the corrected wind direction as a control parameter.

U.S. Pat. No. 7,952,215 is considered as the closest prior art of the mentioned prior art and one problem with the teaching hereof is that it is complicated in that it requires calculation of relationship between output of the wind turbine and wind direction deviation at each wind speed. Another problem is that this way of optimizing the yaw control is only possible when the wind turbine is not derated.

### BRIEF DESCRIPTION OF THE INVENTION

It is therefore according to different aspects of the invention an object to overcome the above mentioned problems by facilitating a method for optimising the alignment of the wind turbine with the wind direction.

This is done by a method of determining an offset angle to the wind direction measured from a wind vane of a wind turbine, the offset angle being used by a wind turbine controller to optimise power output of the wind turbine, the method comprising the steps of: determine speed of the wind preferably by means of an anemometer, determine wind direction preferably by means of the wind vane,

the method is characterized in that it further comprises the steps of: defining a plurality of power bins representing an interval of power which can be produced by the wind turbine, determine an efficiency of the wind turbine for a plurality of time slots, determine the power output of the wind turbine for the plurality of time slots, comparing the efficiency of the wind turbine in two different time slots to obtain a highest efficiency, and updating a value of the power bin representing the interval of output power determined for one of the compared time slots, wherein the value of the power bin is updated with the result of the highest efficiency or a value derived from the highest efficiency multiplied with a constant.

The calculation of efficiency is done while the wind turbine is in operation i.e. producing power and the output power is preferably determined for each of the time slots for which the efficiency is determined.

Preferably the time slot having the highest efficiency is found by the comparison of the two different time slots and the angle measured by the wind vane in this time slot is multiplied with a constant. The value comprised by the power bin representing the interval of power produced during the time slot having the highest efficiency is then updated with the result of the multiplication. Thereby a dynamic and real-time optimization of yaw angle offset is obtained which is independent of the effect different wind speeds has on the measurements from the wind vane.

The steps are repeated as many times as desired and may therefore be executed when the wind turbine producing output power making the present invention a real time dynamic wind vane offset calibration routine.

The power bins are each defined by a range of power i.e. preferably the rated power of the wind turbine is divided in a plurality of power bins. A power bin could cover an interval of e.g. 300 kW e.g. from 300 kW to 600 kW. Preferably all bins represent intervals below the rated output power of the wind turbine but some could define power above if needed.

A wind direction/a power measured during the time slot having the highest is preferably an average of what is measured during the time slot

Steps does not necessary have to be executed in the above mentioned order. However some measurements have to be done before some calculations can be made and some calculations have to be made before some comparisons can be made.

The power bin which value is updated is preferably determined by the power during the time slot having the highest efficiency but could be from any of the compared time slots or an average of the two. The power during a time slot is preferably measured or derived from measurements.

According to an embodiment of the invention, the value of the power bins is the offset angle. This is advantageous in that it can be used directly by the wind turbine controller in controlling the wind turbine

According to an embodiment of the invention, the wind turbine controller is controlling the orientation of the nacelle by adding the offset angle from the power bin representing the real time power output to the wind direction measured by the wind vane. This is advantageous in that then the yaw angle plus the offset angle is aligned with the wind direction step by step until a satisfying alignment is obtained and in this way the calibration of the wind vane is controlled according to the produces output power of the wind turbine.

The wind vane is rotated by the wind and transforms this rotation to angles of wind direction which is used by the wind turbine controller to adjust the nacelle to align the rotor plan with the wind direction. This is referred to as yaw control with the purpose of keeping the rotor plane perpendicular to the wind direction to increase possible energy capture from the wind. Hence when the yaw control is optimal there is an offset angle between the measured angle of wind and the yaw angle of the nacelle of 0° (zero degrees).

When mounting the wind vane at the nacelle there is a risk that the wind vane is not aligned 100% with the direction of the wind. This leads to a wind turbine control which is not optimal. This problem can be solved by determine the calibration offset angle between the wind direction and what is measured by the wind vane for a plurality of different power output intervals.

The anemometer is measuring the wind speed preferably the wind vane and the anemometer are located at the nacelle of the wind turbine.

According to an embodiment of the invention, the efficiency is calculated by dividing an estimated wind speed with the measured speed of the wind.

According to an embodiment of the invention, the estimated wind speed is calculated based on generator torque or generator slip.

According to an embodiment of the invention, the efficiency is calculated by dividing a measured power coefficient with a theoretical power coefficient. The calculation of efficiency is dynamic thereby the value in the power bins are updated real-time

According to an embodiment of the invention, the constant is less than 2, preferably less than 1. The constant is used to multiply with the efficiency to be able to regulate the update of the value of the power bin which is advantages in that each update of the power bin then does not increase or decrease with undesirable step.

According to an embodiment of the invention, the value derived from the highest efficiency is the difference between the efficiencies of compared time slots. It is advantageous if two time slots are compared resulting in two efficiencies one of which is the highest from which a value can be derived. Further it is advantageous if the derived value is the result of the subtraction of the two efficiencies. Further it is advantageous if the derived value is an absolute value in that this will ease the implementation in the control system in that the result in one situation should be used for increasing and in another situation for decreasing the value of the power bin.

According to an embodiment of the invention, the value of the power bin to be updated is increased if the measured wind direction in the time slot having the highest efficiency of the compared time slots is larger than the measured wind direction in the time slot not having the highest efficiency.

According to an embodiment of the invention, the value of the power bin to be updated is decreased if the measured wind direction in the time slot having the highest efficiency of the compared time slots is smaller than the measured wind direction in the time slot not having the highest efficiency. This is advantageous in that after successive executions of the calibration routine of the present invention the value of the power bin is driven towards the final optimized value. Which when used in control of the wind turbine facilitates an optimized control in relation to power output.

According to an embodiment of the invention, the time slots are of duration between 0 and 500 seconds, preferably between 75 and 300 seconds, most preferably between 100 and 150 seconds. The duration of the time slots could be outside the mentioned intervals and up to hours however to increase the time for updating the power bins and thereby the time to successful optimization by means of the present optimization routine time slots between 100 and 150 seconds has turned out to be suitable.

According to an embodiment of the invention, the compared time slots are successive in time. This is advantageous in that it is then possible to follow the trend in direction of the offset providing the most efficient wind turbine and thereby the offset facilitating the highest power output from the wind turbine.

The efficiency of the wind turbine is calculated as the estimated wind speed divided by the measured wind speed preferably resulting in a value between 0 and 1 where the maximum efficiency is 1. The range is secondary and could also be between 0 and 2 with 2 as maximum (or other ranges) e.g. in a situation where the estimated wind speed is higher than the measured. The measured wind speed is measured by the anemometer. The estimated wind speed is estimated based on the data acquired from the generator or converter related to either generator torque (converter of a variable speed wind turbine) or generator slip (generator of a stall controlled wind turbines).

A bin is defined by an interval of offset angles i.e. angles of the wind measured by the wind vane.) Hence one bin may represent efficiencies calculated with the nacelle in one yaw angle at the same time as the wind vane measures an angle of the wind from another angle. As examples could be mentioned a first bin between 0 and 1 degree, a second bin between 0 and −1 degree, a third bin between 1 and 2 degrees and so on. Hence the bins are preferably defined by what is referred to as offset angles though out this document. The offset angles are illustrated on FIG. 5 as function of efficiency and wind direction and illustrated in bins on FIGS. 3a and 3b

When the steps of the inventive method has been repeated a plurality of times each bin will comprise a plurality of calculated efficiencies. This is because the nature of the wind direction (as well as the wind speed) diverging i.e. direction (and speed) are not constant.

As mentioned the maximum efficiency is when the wind direction is perpendicular to the rotor plane. Hence for all the bins all calculated efficiencies are averaged resulting in one average efficiency for each bin see FIG. 3b. Then by comparing the average efficiency of each bin it is easy to determine which bin and thereby at which offset angle the operation of the wind turbine is most efficient.

This offset angle representing the bin representing the highest efficiency is then referred to as calibration offset angle and the wind vane is the preferably calibrated with this angle be means of a correction in the control software according to an aspect of the invention. Hence the calibration offset angle may then be applied to the angle measured by the wind vane (i.e. measured data related to an angle of the wind) to better align the yaw angle of the nacelle with the direction of the wind and thereby increase efficiency of the production of power by the wind turbine.

According to an embodiment of the invention, the calculation of the representation of the efficiency of each bin is done by averaging the efficiencies of the bin. For a more precise average and thereby efficiency of the bin, it might be advantageous to remove outliers before performing the averaging of efficiencies.

According to an embodiment of the invention, the generator torque is acquired from the converter. Preferably the generator torque is acquired from the converter of the where it is estimated by the converter based on measurements of generator current

This way of acquiring information of the generator torque is especially advantageous for variable speed wind turbines.

According to an embodiment of the invention, the generator slip is acquired by measuring the generator speed at the generator. This way of acquiring information of the generator slip is torque is especially advantageous for non-variable speed wind turbines such as stall controlled wind turbines.

According to an embodiment of the invention, the steps are repeated for a predetermined period of time of at least 2 hours preferably at least 5 hours most preferably at least 10 hours of production of power. The more efficiencies which are stored in each bin the more precise the average of the efficiencies of the bins would be. Hence the longer the data collection/data calculation period is the more precise the average could be expected to be. It has been found that a period of time of more than e.g. five hours is sufficient for getting an indication of the offset angle according to an aspect of the invention.

It should be mentioned that the predetermined period of time is preferably only counting when the wind turbine is producing a power output which is preferably delivered power to the utility grid.

The predefined period of time does not have to be reset and start over in case the wind turbines stops production of power. In such case the stored data (e.g. efficiencies of the different bins) is simply kept and when the wind turbine again produces power new data is added to the stored data (e.g. new efficiencies are added to the different bins).

According to an embodiment of the invention, the steps of measuring and acquiring are repeated at least once every 5 seconds, preferably at least every 3 second or most preferably at least every second. The frequency of measuring and acquiring data is determining the frequency of the calculations, storing and determination which are all made when the relevant data is available.

Preferably the frequency of repeating the measuring and acquiring steps may be determined by the nature of the wind at the site of the wind turbine. Hence if the site is offshore the steps may not have to be repeated as often as if the site is onshore in that wind is more stable than onshore.

According to an embodiment of the invention, the calibration offset angle is estimated based on data measured and acquired during a period where the wind turbine is derated. Even though it is not advantageous when looking a revenue of the wind turbine it is sometimes necessary e.g. because of requirements to noise reduction, grid requirements, defect or malfunctioning components of the wind turbines, etc.

According to an embodiment of an aspect of the invention, the measurements from the wind vane are calibrated based on the determined calibration offset angle. This is very advantageous in that the yaw misalignment is then substantially eliminated and thereby the wind turbine is providing a higher yield compared to producing without correcting yaw angle with the calibration offset angle.

Moreover the invention relates to a method of controlling the wind turbine by adjusting a yaw control set point with a calibration offset angle determined from a method according to any of the preceding claims.

Moreover the invention relates to the use of a calibration offset angle determined according to any of the preceding claims for controlling the yaw angle of a wind turbine.

### FIGURES

A few exemplary embodiments of the invention will be described in more detail in the following with reference to the figures, of which

FIG. 1 illustrates a wind turbine according to an embodiment of the invention,

FIG. 2 illustrates the offset angle according to an embodiment of the invention,

FIG. 3a illustrates a plurality of bin according to an embodiment of the invention,

FIG. 3b illustrates the bins of FIG. 3a with averaged efficiencies, and

FIG. 4 illustrates a plot of efficiency versus wind direction,

FIG. 5 illustrates efficiencies and wind directions of successive time slots, and

FIG. 6 illustrates power bins.

### DETAILED DESCRIPTION OF THE INVENTION

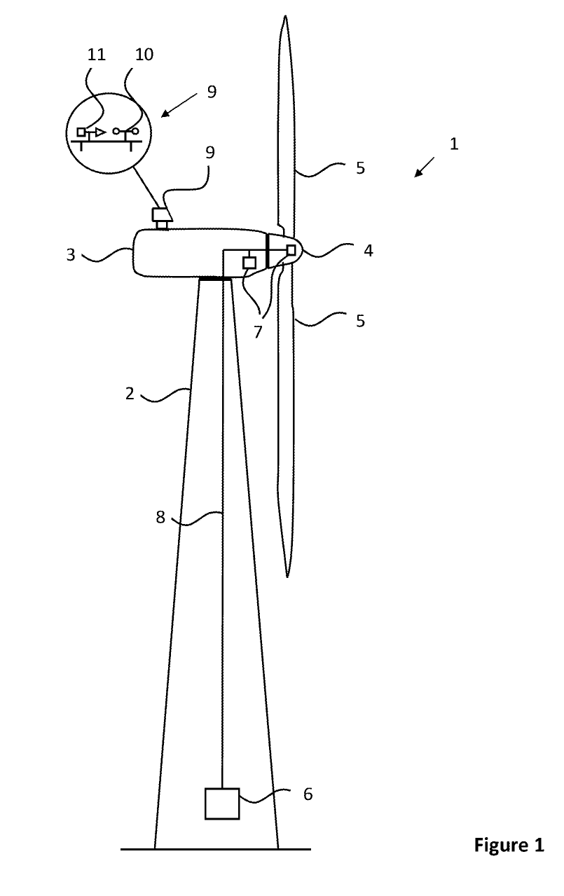

FIG. 1 illustrates an electrical power generating system in form of a wind turbine 1 according to an embodiment of the invention. The wind turbine 1 comprises a tower 2, a nacelle 3, a hub 4 and two or more blades 5. The blades 5 of the wind turbine 1 are rotatable mounted on the hub 4, together with which they are referred to as the rotor. The area covered by the blades 5 when the rotor rotates is referred to as rotor plane. The rotation of a blade 5 along its longitudinal axial is referred to as pitch.

The wind turbine 1 is controlled by a control system comprising a wind turbine controller 6, sub controllers 7 for controlling different parts of the wind turbine 1 and communication lines 8. The wind turbine controller 6 is preferably communication with external controllers (not illustrated) and operators (not illustrated) via not illustrated communication lines. Hence it is possible to update, correct, check status, etc. the wind turbine controller 6 and software thereon.

On top of the nacelle 3 a weather station 9 is illustrated comprising an anemometer 10 (for measuring wind speed) and a wind vane 11 (for measuring wind direction).

The wind turbine 1 generates electric power from the wind which makes the rotor rotate. The rotor is coupled to a generator which generates the electric power. The power generated from the generator is in variable speed wind turbines shaped by a converter to comply with grid codes of the local utility grid. Some wind turbines such as stall controlled wind turbines, have no converter and is coupled directly to the utility grid.

Hence there is a relationship between the wind acting on the rotor and the load on the generator. The generator torque may be acquired from measurement made in the converter or from calculations made by the converter. The converter may measure the generator current which forms basis for calculating the generator torque. Alternatively, the generator slip may be determined based on difference in speed between the generator synchronous speed and the measured generator speed.

The ways of producing energy from a wind turbine 1 and the components such as generator and converter used hereto is not illustrated nor explained further in that it is how wind turbines 1 are operating and thereby known by the skilled person.

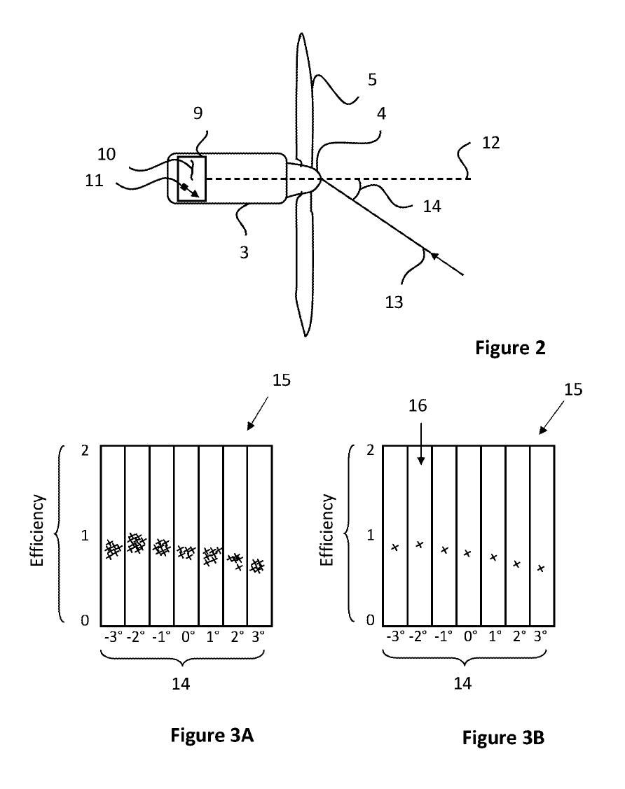

FIG. 2 illustrates the nacelle 3, hub 4 and blades 5 of the wind turbine 1 in a top view. Further FIG. 2 illustrates the direction of the nacelle which is referred to as yaw angle 12 (dotted line). The yaw angle 12 describes the alignment of the nacelle and thereby the rotor plan with the wind direction 13 (solid line). The wind direction 13 is the actual wind direction measured by the wind vane 11. Since the weather station 9 and thereby the wind vane 11 is rotating with the nacelle 3, then in the ideal situation the yaw angle 12 is aligned with the wind direction 13 measured by the wind vane 11 leading to an offset angle 14 of 0°.

In reality, there will most often be an offset angle 14 between the yaw angle 12 and the wind direction 13 measured by the wind vane 11. More precise the wind direction 13 or measured data related to an angle of the wind measured by the wind vane 11 is this offset angle 14. Therefore this offset angle 14 could be interpreted as an error and is sometimes referred to as yaw misalignment. This yaw misalignment should be corrected by the wind turbine controller 6 in order to increase efficiency of the wind turbine 1 (e.g. increase production of power from the wind turbine 1). However, the wind is often not very stable and further more since the wind vane 11 is located behind the blades 5 the turbulence induced by the blades 5 will also have an effect on the wind direction 13 measured by the wind vane 11. Therefore it is not desired to control the yaw angle 12 based on the real time measurements of the wind vane 11 in that this will lead to an undesired more or less constant adjustment of the yaw angle 12.

A first aspect of the invention will now be described in more details following a description of a second aspect of the invention. The second aspect of the invention is at least partly based on the first aspect. However it is not necessary to implement each and every feature of the first aspect to implement calibration of the wind vane 11 according to the second aspect.

According to a first aspect of the present invention this offset angle 14 measured by the wind vane 11 is stored in a data storage (not illustrated) together with measurements of wind speed from the anemometer 10 and data related to generator torque or generator slip. The data storage may be part of the wind turbine controller 6 or communicatively connected hereto.

This data is used for calculating an efficiency of the wind turbine 1. The efficiency is typically defined as a number between 0 and 2, where 2 is maximum efficiency based on the following equation 1 (alternative ranges may also be used):

Efficiency=V_{estimated}/V_{measured} eq1)

Where:

V_{estimated} is the estimated wind speed calculated by equation 2 below

V_{measured} is the measured wind speed measured by the anemometer 10

The relationship between generator torque and wind speed may be expressed by the following equation 2:

T=½×ρ×V²×A×Cq eq 2)

Where:
T is the generator torque (relationship between generator torque and generator slip may be found from a look-up table related to the specific generator configuration)
V is the wind speed (the unknown quantity in this equation)
ρ (rho) is a constant representing air density (ρ may be measured to improve the result of the equation)
A is the area of the rotor plane
Cq is a constant defined by the design of the blades. More specific this value could be referred to as Cq(λ,θ) where λ (lambda) represents the tip speed ratio (relationship between wind speed (V) and speed of blade tip (ω) (omega)) and where θ (theta) represents the pitch angle. The Cq values is typically found from a table made when design of the wind turbine 1/blades 5 is finished.

From equation 2 it is noticed that the only unknown quantity is the wind speed V and thereby it is relatively easy to estimate this wind speed based on the other quantities of the equation and thereby arrive at V_{estimated} which is needed for equation 1.

Hence from equation 1 it is now possible to calculate the efficiency of the wind turbine 1 with an offset angle 14 measured by the wind vane 11 with the nacelle positioned in the yaw angle 12. The calculated efficiency is then stored in the data storage in a bin 15 which matches this offset angle 14.

It should be understood that what is calculated and referred to as the efficiency should in this document be understood as a measure reflecting the production of power of the wind turbine compared to the maximum production under the given circumstances. Circumstances could e.g. include wind speed, defects of components, etc. Hence the calculated efficiency could also be referred to as a representation of efficiency in that there might be other ways of reflect this relationship

In the data storage a plurality of bins 15 are created each bin 15 representing one or more offset angles 14. Preferably each bin 15 represents one offset angle 14 making a first bin 15 representing offset angles 14 between 0° and 1°, a second bin 15 representing offset angles 14 between 0° and −1°, a third bin 15 representing offset angles 14 between 1° and 2° and so on. Hence the bins are created sometime before the measured data related to at least one angle of the wind i.e. the offset angle 14 for use in embodiments of the present invention is made and may therefore be referred to as predefined.

When the wind direction 13 and thereby the offset angle 14 (measured by the wind vane 11) for a predetermined period of time has been above or below a predetermined threshold the yaw angle 12 changes. Therefore when the steps leading to the calculated efficiency of the wind turbine 1 is repeated a plurality of times over a period of time counted in hours or days preferably at least between 5 and 15 hours the resulting plurality of different efficiencies are stored in a plurality of different bins 15 related to different offset angles 14.

FIG. 3A and 3B serves to illustrate efficiencies (each efficiency is represented by “X”) in the seven different bins 15 defined by offset angles 14 illustrated at FIG. 3A and 3B. In FIG. 3B the offset angle 14 at which the efficiency of the wind turbine 1 is highest is denoted 16 i.e. −2°.

Ideally all efficiencies should be stored in the 0° bin 15 this would indicate that the yaw angle 12 of the nacelle 3 was always aligned with the wind direction 13 measured by the wind vane 11 (i.e. with an offset angle 14 at 0°). In this ideal situation the wind direction would be substantially perpendicular to the area of the rotor plane.

In FIG. 3B the result of averaging the efficiencies of each bin 15 is illustrated. Here it is seen that in this example the wind turbine 1 has the highest efficient in the bin 16 representing an offset angle 14 of −2° (minus 2 degrees). From this information it is derived that the rotor plane is more aligned with the wind direction 13 at a yaw angle 12 of −2° (which is therefore referred to as calibration offset angle) which indicates that the wind vane 11 is not calibrated correct.

To compensate for the offset error/yaw misalignment in this example the calibration offset angle of −2° should be added to the yaw angle 12. In this way the yaw angle 12 would be aligned with the direction of the wind 13 (as measured by the wind vane 11) and the offset angle 14 would be 0°.

Offset angle (−2)+yaw angle (0)=compensation (−2)

Thereby the yaw control of the wind turbine 1 is optimised to increase the efficiency of the wind turbine 1 based on a determined calibration offset angle according to the present invention.

Alternatively the measurements from the wind vane 11 should be subtracted the calibration offset angle of −2° degrees which would also end up aligning the yaw angle with the wind direction 13 and thereby the offset angle 14 is again 0°.

Offset angle (−2)−Offset angle (−2)=compensation (0)

Any of the methods of compensating the offset angle 14 with the calibration offset angle may be implemented by the wind turbine controller 6 e.g. by correcting either the setpoint to the yaw control changing the yaw angle 12 or correcting the received measurement from the wind vane 11 before used for control purposes by the wind turbine controller 6.

Thereby is in a simple manner and with no requirements to equipment other than what is already existing on the wind turbine 1 obtained a method which when used in control of a wind turbine 1 is increasing the efficiency of a wind turbine 1 in that the yaw angle 12 of the wind turbine controlled according to the determined calibration offset angle will be more aligned with the at all-time current wind direction 13.

The inventive method of determining a calibration offset angle could be repeated on a regular basis e.g. once every month (could be more often or more rare) to take into account that the measurements from the wind vane 11 may drift e.g. due to wear of the wind vane 11.

As mentioned the present invention is advantageous in that it is not limited by the fact that the operation of the wind turbine 1 is derated i.e. not producing a nominal output even though the wind speed allows this. Derating of a wind turbine 1 is not favourable in that production is limited but may be required e.g. due to noise reduction requirements, grid requirements, malfunction or alarms related to a component for the wind turbine 1, etc.

Therefore the above description of a first aspect of the present invention relates to a method of determining a calibration offset angle which when used in control of the wind turbine can increase the efficiency of the wind turbine, the method comprising the steps of: measuring data related to speed and direction of the wind, acquiring data related to the generator, calculating an estimated speed of the wind based on the data related to generator, calculating an efficiency of the wind turbine based on the estimated wind speed and the measured wind speed, storing the calculated efficiency in a bin representing measured data related to at least one angle of the wind, wherein an efficiency of each bin is calculated, and the calibration offset angle is determined as the angle of the wind representing the bin representing the highest efficient.

Below is a description of a second aspect of the invention which as mentioned reuses elements of the above described first aspect.

According to the second aspect of the present invention a calibration offset angle is defined in relation to output power of the wind turbine 1. Hence the wind turbine controller 6, 7 may, by knowledge of present power production determine an offset angle to the angle measured by the wind vane 11. This facilitates an optimized control parameter especially the yaw angle or yaw angle offset resulting in higher power output of the wind turbine 1.

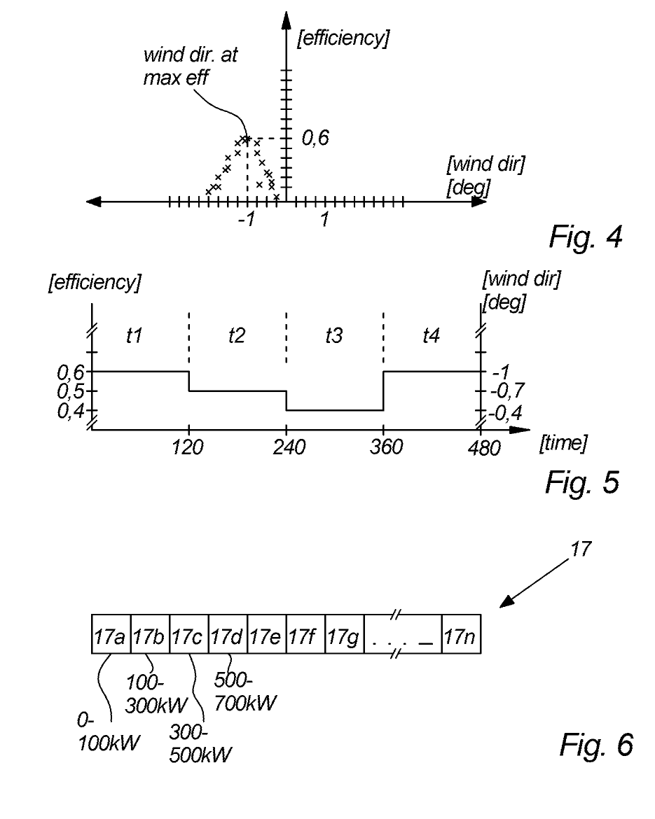

A preferred embodiment of the second aspect of the invention will now be described in relation to FIGS. 4, 5 and 6. The efficiency of the wind turbine 1 according to this preferred embodiment is found as described above in relation to the first aspect of the present invention. Further all aspects of the first embodiment is useable in this second aspect (and vice versa) such including control of the wind turbine and executing the described method of optimizing the control.

FIG. 4 illustrates the efficiencies plotted in relation to wind direction measured by the wind wane 11. From FIG. 4 it is found that the efficiency peaks at 0,6 at a wind direction which is minus 1 degree from the value measured by the wind vane 11.

Accordingly it must be assumed that the wind vane is not calibrated correct to keep the rotor plan of the wind turbine 1 perpendicular to the wind direction.

FIG. 5 illustrates a plot of the calculated efficiency and wind direction measured by the wind vane 11 during four time slots t1, t2, t3, t4. The example illustrated at FIG. 5 is an example where the wind turbine 1 is optimized towards a negative offset value (offset and calibration angles are both used as reference to the angle 14). FIG. 5 does not illustrate time slots where the optimization is going towards a positive offset angle (or error measurements which in FIG. 5 would indicate positive offset angle).

The time slots on the illustrated example are 120 second however time slots are not limited to 120 seconds and could be either shorter or longer. During each of the time slots t1-t4, the measurements and calculations are preferably averaged resulting in the illustrated horizontal graph illustrated on FIG. 5.

It can be seen that at −1 degree the efficiency is 0,6 (t1 and t4), at −0,7 degrees the efficiency is 0,5 (t2) and at −0,4 degrees the efficiency is 0,4 (t3). Accordingly from FIG. 5 it can be derived that the efficiency of the wind turbine 1 is highest when the measured offset below 0 degrees.

In addition to the measured wind direction and the calculated efficiency of each time slot the power output in each time slot is found either by directly measuring it or calculations. It is preferred that the output during each time slot is averaged however this is not mandatory.

According to an embodiment, a wind turbine controller (main controller 7 or sub-controller 6) is comparing two successive time slots e.g. time slot t1 with time slot t2 and time slot t3 with time slot t4 or the like.

Each of the power bins 17 illustrated on FIG. 6 comprise a calibration angle for the wind vane 11 use when the output produced by the wind turbine 1 is in the range represented by the individual power bins 17. These values are updated based on the comparison as described below.

The (present) output power should be understood as the output power of the wind turbine (averaged, single measurement or other ways of representation) during the compared time slots (t1-t4).

Hence the calibration angle of the power bin 17 representing the range of the present output power of the wind turbine is increased if the highest efficiency is found in the time slot with the largest measured wind direction of the compared time slots.

If the highest efficiency is found in the time slot with the smallest measured wind direction of the compared time slots the calibration angle of the power bin 17 representing the range of the present output power of the wind turbine is decreased.

Preferably the calibration angle of the power bin 17 is increased/decreased with the difference of efficiency between the two compared time slots multiplied by the constant.

Hence update of the value of the power bin (i.e. the value comprised by the power bins are the offset/calibration angle 14) after the comparison of time slots is preferably done by increasing or decreasing the existing value of the power bin 17 with the result of the efficiency (or difference between efficiencies of time slot) multiplied with a constant.

Largest and smallest measured wind direction is found from comparison of wind direction measured in the compared time slots i.e. an angle of −1 is smaller than on of −0,7 and an angle of 1 is larger than on of 0,7.

The value of the constant is found by simulation or experiments preferably of the specific wind turbine type i.e. with known rotor size and electrical and mechanical components. It has turned out that a constant below 2 preferably below 1 is suitable in most situations.

The rationale behind the increasing and decreasing of calibration angle of the power bins 17 is as indicated above that the measured wind direction angle of the time slot having the highest efficiency is indicating that an optimal calibration angle to the measured angle from the wind vane 11 should be found in the direction of the angle of the time slot having the highest efficiency. When this is linked to the produce output power, the produced output power can be used for the calibration of the wind vane 11. More specific a calibration offset angle is found in the power bin 17 representing the interval of output power produced by the wind turbine 1. In this way the present invention does not have to account for different off set angles at different wind speeds.

In the situation where the wind direction is not changed during two successive time slots, no changes have to be made to the calibration angle of the power bins 17. In fact if the efficiencies between two time slots are low going towards the same value this may indicate that the calibration angles of the power bins 17 are optimized.

Accordingly the optimization routine could be stopped at least for some time. During such time wear of the wind turbine parts may cause the need for running the optimization routine again.

Now turning to FIGS. 5 and 6, the wind turbine controller 6, 7 updates the calibration angle of the relevant power bin 17 according to the result of the comparison as described above. As indicated if the optimization routine of the present invention is running it is running dynamically and thereby the present invention could be referred to as a dynamic or adaptive method or routine for optimizing or calibrating the angle of wind measured by the wind vane 11.

First time slot t1 and time slot t2 are compared and as can be seen from FIG. 5 the efficiency is highest in time slot t1 (0,6) where the measured wind direction is −1 degree (in t2 the efficiency is 0,5 and the angle is −0,7).

This means that if the output power during time slot t1 is 450 kW, the calibration angle of power bin 17C is decreased with the result of the efficiency difference between t1 and t2 i.e. 0,6 −0,5=0,1 (efficiency t1 subtracted efficiency t2 resulting in a derived value from the highest effeciency) multiplied by the constant (e.g. 0,7) described above. Hence the value of 0,1×0,7=0,07 is subtracted from the existing value of calibration angle comprised by power bin 17C.

As mentioned the decrease of the calibration angle of power bin 17C is in this case due to the fact that −1 degree (from t1) is smaller than −0,7 degrees (from t2) (−1<−0,7).

In the same way if the efficiency of time slot t3 (0,4) and t4 (0,6) is compared and the output during time slot t4 is 600 kW the value of power bin 17d is decreased by 0,2 multiplied by the constant because the measured angle is smaller in t4 (−1) compare to t3 (−0,4) (−1<−0,4).

As mentioned FIG. 6 illustrates a plurality of power bins together referred to with reference number 17. Each of the individual power bins 17a, 17b, . . . 17n represents an output interval of the wind turbine 1 and comprising a calibration angle for the measurement of the wind vane 11 when the wind turbine 1 produced the output power represented by the power bin 17. Hence bin 17a may represent output between 0 kW and 100 kW, 17b from 100 kW to 300 kW, 17c from 300 kW to 500 kW and so forth up to rated power of the wind turbine 1.

It should be mentioned that in relation to both aspects of the invention the efficiency could also be found by dividing a measured power coefficient with a theoretical power coefficient. The efficiency (e.g. an average efficiency) of the wind turbine for a period of time may be found as the ratio between a measured power coefficient and a theoretical power coefficient at a given pitch angle.

The measured power coefficient can be calculated based on the following equation:

$${C}_{{p}_{Measured}} = \frac{{P}_{electrical}}{{v}_{measured}^{3} {D}_{rotor}^{2} {ρ}_{air} \frac{π}{8}}$$

Where:
C_{pMeasured}: Power efficiency based on measured values
v_{measured}: Measured wind speed from anemometer [m/s]
P_{electrical}: Measured produced electrical power [W]
Dᵣₒₜₒᵣ: Rotor diameter [m]
ρₐᵢᵣ: Air density [kg/m³]

The theoretical power coefficient can be found based on the following equation:

$$λ = \frac{{ω}_{gen} \frac{1}{2} {D}_{rotor}}{{v}_{measured} {η}_{gear}}$$

Where:
λ: Tip speed ratio
v_{measured}: Measured wind speed from anemometer [m/s]
Dᵣₒₜₒᵣ: Rotor diameter [m]
θ_{gear}: Gear box ratio [−]
ω_{gen}: Generator speed [rad/s]

Based on the calculated tip speed ratio and the actual pitch position a two dimensional look-up table is used to find the theoretical power efficiency Cₚ also referred to as blade data. This blade data look-up table has the tip speed ratio in one direction and actual pitch position in the other. Accordingly the output from the look-up table gives the theoretical power efficiency Cₚ.

By performing the above described calculation of efficiency, measuring of wind direction, comparing of efficiency in different time slots, calculating of value for updating power bin 17 a dynamic and adaptive optimization of wind turbine control is obtained.

Hence after the time period defining the first two time slots the first indication of and basis for an offset angle for optimization of the wind turbine control is obtained. As more time slots are compared and more power bins 17 thereby are updated the more accurate and precise the offset angles are for the given power output.

The wind turbine controller 6, 7 can then be based on the present output power which via the power bins 17 determines an offset angle to be added to the measured wind direction from the wind vane 11. In this way the present invention are using the power output at indicator for different wind speeds which have influences of the error measured by the wind vane 11.

The dynamic optimization routine described in this document with reference to the first and second aspect and combination hereof can be controlled by the main wind turbine controller or a sub controller. It can be executed when the wind turbine 1 is producing energy and/or at spaced time periods during the lifetime of the wind turbine. The result of the control according to the values of the power bins 17 is that the yaw angle 12 plus the offset angle 14 is aligned with the wind direction 14 step by step until a satisfying alignment is obtained. The value of the power bins 17 is preferably an offset angle which can be used directly by the wind turbine controller 6, 7 in the control of the wind turbine 1

The present invention is advantageous in that it can be executed as long as the wind turbine produces power even in the situation where the wind turbine is derated i.e. controlled to produce less than rated power. Beside this advantage over the cited prior art, then by using the present invention the need for performing optimization calculations for each wind speed is eliminated. Accordingly optimization according to the present invention is much faster compared to prior art methods which will need many measurements at each wind speed to be able to determine an offset for each of these wind speeds.

### LIST OF REFERENCE NUMBERS

1. Wind turbine

2. Tower

3. Nacelle

4. Hub

5. Blade

6. Wind turbine controller

7. Sub controller

8. Communication line

9. Weather station

10. Anemometer

11. Wind vane

12. Yaw angle

13. Wind direction

14. Offset angle

15. Bin

16. Bin representing the calibration offset angle

17. Power bin

What is claimed is:

1. A method of determining an offset angle to the wind direction measured from a wind vane of a wind turbine, the offset angle being used by a wind turbine controller to optimise power output of the wind turbine, the method comprising the steps of:
determine speed of the wind preferably by means of an anemometer,
determine wind direction preferably by means of the wind vane,
the method is characterized in that it further comprises the steps of:
defining a plurality of power bins representing an interval of power which can be produced by the wind turbine,
determine an efficiency of the wind turbine for a plurality of time slots,
determine the power output of the wind turbine for the plurality of time slots,
comparing the efficiency of the wind turbine in two different time slots to obtain a highest efficiency, and
updating a value of the power bin representing the interval of output power determined for one of the compared time slots, wherein the value of the power bin is updated with the result of the highest efficiency or a value derived from the highest efficiency multiplied with a constant.

2. The method of determining an offset angle according to claim 1, wherein the value of the power bins 17 is the offset angle.

3. The method of determining an offset angle according to claim 2, wherein the wind turbine controller is controlling the orientation of the nacelle by adding the offset angle from the power bin representing the real time power output to the wind direction measured by the wind vane.

4. The method of determining an offset angle according to claim 1, wherein the efficiency is calculated by dividing an estimated wind speed with the measured speed of the wind or by dividing a measured power coefficient with a theoretical power coefficient.

5. The method of determining an offset angle according to claim 4, wherein the estimated wind speed is calculated based on generator torque or generator slip.

6. (canceled)

7. The method of determining an offset angle according to claim 1, wherein the constant is less than 2.

8. The method of determining an offset angle according to claim 1, wherein the value derived from the highest efficiency is the difference between the efficiencies of compared time slots.

9. The method of determining an offset angle according to claim 1, wherein the value of the power bin to be updated is increased if the measured wind direction in the time slot having the highest efficiency of the compared time slots is larger than the measured wind direction in the time slot not having the highest efficiency.

10. The method of determining an offset angle according to claim 1 wherein the value of the power bin to be updated is decreased if the measured wind direction in the time slot having the highest efficiency of the compared time slots is smaller than the measured wind direction in the time slot not having the highest efficiency.

11. The method of determining an offset angle according to claim 1, wherein the time slots are of duration between 0 and 500 seconds.

12. The method of determining an offset angle according to claim 1, wherein the compared time slots are successive in time.

13. The method of determining an offset angle according to claim 1, wherein the calculation of the representation of the efficiency of each bin is done by averaging the efficiencies of the bin.

14. The method of determining an offset angle according to claim 1, wherein the generator torque is acquired from the converter.

15. The method of determining an offset angle according to claim 1, wherein the generator slip is acquired by measuring the generator speed at the generator.

16. The method of determining an offset angle according to claim 1, wherein the steps are repeated for a predetermined period of time of at least 2 hours of production of power.

17. The method of determining an offset angle according to claim 1, wherein the steps of measuring and acquiring are repeated at least once every 5 seconds.

18. The method of determining an offset angle according to claim 1, wherein the calibration offset angle is estimated based on data measured and acquired during a period where the wind turbine is derated.

19. The method of determining an offset angle according to claim 1, wherein the measurements from the wind vane are calibrated based on the determined calibration offset angles.

20. The method of controlling the wind turbine by adjusting a yaw control set point with an offset angle determined from a method according to claim 1.

21. Use of an offset angle determined according to claim 1 for controlling the yaw angle of a wind turbine.
